(19) United States
(12) Patent Application Publication
(10) Pub. No.: US 2020/0162541 A1
(43) Pub. Date: May 21, 2020

(54) SYSTEMS AND METHODS FOR UPLOADING DATA

(71) Applicant: BEIJING DIDI INFINITY TECHNOLOGY AND DEVELOPMENT CO., LTD., Beijing (CN)

(72) Inventors: Hao LI, Beijing (CN); Liang XUE, Beijing (CN); Xudong ZHANG, Beijing (CN)

(73) Assignee: BEIJING DIDI INFINITY TECHNOLOGY AND DEVELOPMENT CO., LTD., Beijing (CN)

(21) Appl. No.: 16/711,482

(22) Filed: Dec. 12, 2019

Related U.S. Application Data
(63) Continuation of application No. PCT/CN2017/088196, filed on Jun. 14, 2017.

(51) Int. Cl. H04L 29/08; G06F 16/23

(52) U.S. Cl. CPC H04L 67/10; G06F 16/2379

(57) ABSTRACT

The present disclosure relates to systems and methods for uploading data. The system may perform the methods to acquire a first data item from a database; acquire a second data item, wherein the second data item may be an updated version of the first data item; determine an increment data item based on the first data item and the second data item; determine an updating strategy with respect to the increment data item; and transmit the increment data item to update the first data item stored in the database via a network based on the updating strategy.

### CROSS-REFERENCE TO RELATED APPLICATIONS

This application is a continuation of International Application No. PCT/CN2017/088196, filed on Jun. 14, 2017, the contents of which are incorporated herein by reference in entirety.

### TECHNICAL FIELD

The present disclosure generally relates to systems and methods for uploading data, and in particular, systems and methods for uploading offline data.

### BACKGROUND

With the development and popularization of mobile computing technology and wireless communication technology, mobile applications are playing a significant role in people's daily life. At present, the amount of data generated by the mobile applications is huge, so it may be desirable to provide systems and methods for managing (e.g., processing, maintaining, uploading, etc.) the huge amount of data.

### SUMMARY

According to an aspect of the present disclosure, a system is provided. The system may include at least one processor, at least one non-transitory computer-readable storage medium, and at least one communication module connected to a network. The at least one non-transitory computer-readable storage medium may include a set of instructions for updating data. When the at least one processor executes the set of instructions, the at least one processor may be directed to perform one or more of the following operations. The at least one processor may acquire a first data item from a database. The at least one processor may acquire a second data item, wherein the second data item may be an updated version of the first data item. The at least one processor may determine an increment data item based on the first data item and the second data item. The at least one processor may determine an updating strategy with respect to the increment data item. The at least one processor may transmit the increment data item to update the first data item stored in the database via the network based on the updating strategy.

In some embodiments, the at least one processor may filter the first data item and the second data item. The at least one processor may classify the first data item and the second data item. The at least one processor may standardize the first data item and the second data item, which refers to transform the first data item and the second data item to be in the same data structure.

In some embodiments, the at least one processor may perform a subtraction operation between the first data item and the second data item.

In some embodiments, the updating strategy with respect to the increment data item may be based on at least one of data structure of the increment data item, a size of the increment data item, or a type of the increment data item.

In some embodiments, the updating strategy may include at least one of entire updating of the first data item stored in the database, increment updating of the first data item store in the database, or data rollback of the first data item stored in the database.

In some embodiments, the at least one processor may transmit the increment data item to a proxy server. And then the at least one processor may transmit the increment data item from the proxy server to at least one server to update the first data item stored in the database.

In some embodiments, the at least one processor may monitor at least one of data traffic in the network, anomalous data in the network, or data statistics associated with the increment data item.

According to another aspect of the present disclosure, a method is provided. The method may include one or more of the following operations. A processor may acquire a first data item from a database. The processor may acquire a second data item which is an updated version of the first data item. The processor may determine an increment data item based on the first data item and the second data item. The processor may determine an updating strategy with respect to the increment data item. The processor may transmit the increment data item to update the first data item stored in the database via a network based on the updating strategy.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary data uploading system according to some embodiments of the present disclosure;

FIG. 2 is a schematic diagram illustrating exemplary hardware and/or software components of an exemplary computing device according to some embodiments of the present disclosure;

FIG. 3 is a block diagram illustrating an exemplary server according to some embodiments of the present disclosure;

FIG. 4 is a flowchart illustrating an exemplary process for uploading offline data according to some embodiments of the present disclosure;

FIG. 5 is a block diagram illustrating an exemplary processing module according to some embodiments of the present disclosure;

FIG. 6 is a flowchart illustrating an exemplary process for processing offline data according to some embodiments of the present disclosure;

FIG. 7A illustrates a diagram of an exemplary uploading procedure according to some embodiments of the present disclosure;

FIG. 7B illustrates a diagram of an exemplary uploading procedure according to some embodiments of the present disclosure;

FIG. 7C illustrates a diagram of an exemplary uploading procedure according to some embodiments of the present disclosure; and

FIG. 8 is a flowchart illustrating an exemplary process for monitoring the uploading procedure according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

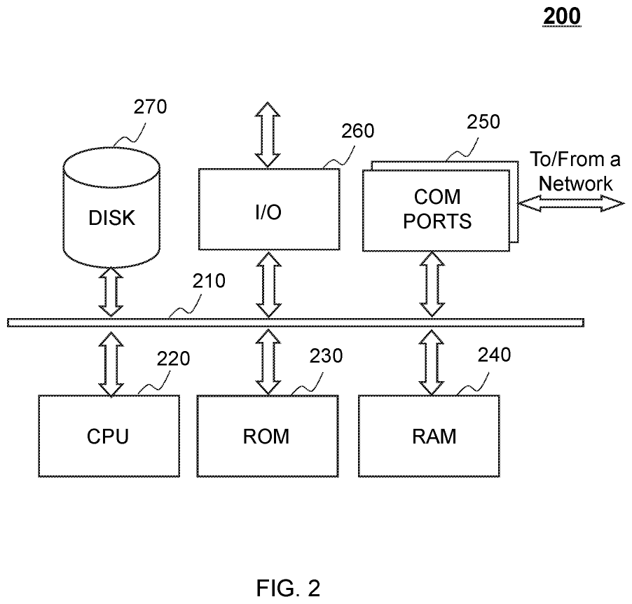

Generally, the word “module” or “unit” as used herein, refers to logic embodied in hardware or firmware, or to a collection of software instructions. A module or a unit described herein may be implemented as software and/or hardware and may be stored in any type of non-transitory computer-readable medium or other storage device. In some embodiments, a software module/unit may be compiled and linked into an executable program. It will be appreciated that software modules can be callable from other modules/units or from themselves, and/or may be invoked in response to detected events or interrupts. Software modules/units configured for execution on computing devices (e.g., processor 220 as illustrated in FIG. 2) may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in a firmware, such as an EPROM. It will be further appreciated that hardware modules/units may be included in connected logic components, such as gates and flip-flops, and/or can be included of programmable units, such as programmable gate arrays or processors. The modules/units or computing device functionality described herein may be implemented as software modules/units, but may be represented in hardware or firmware. In general, the modules/units described herein refer to logical modules/units that may be combined with other modules/units or divided into sub-modules/sub-units despite their physical organization or storage. The description may be applicable to a system, an engine, or a portion thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the systems and methods in the present disclosure are described primarily regarding uploading offline data, it should also be understood that this is only one exemplary embodiment. The systems and methods of the present disclosure may be applied to any other kind of uploading ways. For example, the systems and methods of the present disclosure may be applied to data updating systems of different environments including offline updating, online updating, real-time updating, or the like, or any combination thereof. For another example, the systems and methods of the present disclosure may be applied to data synchronizing systems. The application of the systems and methods of the present disclosure may include one or more terminal devices, a database, one or more servers, a proxy server, a network, or the like, or any combination thereof.

An aspect of the present disclosure relates to systems and methods for synchronizing the online data with the offline data via merely uploading incremental data between the online data and the offline data. The systems and methods may receive the offline data from various sources including a terminal (e.g., a driver terminal or a passenger terminal), a local server, a local storage device, etc. The systems and methods may determine the difference between the offline data and the online data previously downloaded to a local device, and generate incremental data for uploading. The systems and methods may further determine one or more strategies for uploading the incremental data to an online server and/or an online storage device, updating the online data corresponding to the incremental data in the online server and/or the online storage device, and storing the updated online data in the online server and/or the online storage device.

It should be noted that the data receiving and processing are executed offline. Then the system may detect whether there is a network connecting to the executing module. If there is a network, the processed data may be uploaded to a server. If not, the processed data may be stored in a database or current server temporarily waiting for uploading when the server connects to a network. In some embodiments, there may be a proxy server for relaying the data to servers.

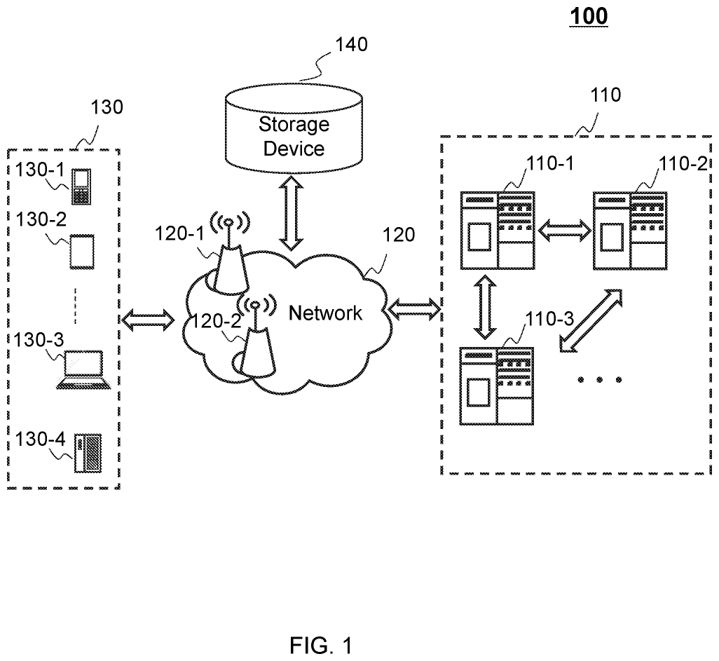

FIG. 1 is a schematic diagram illustrating an exemplary data uploading system according to some embodiments of the present disclosure. For example, the data uploading system 100 may be a data uploading platform for updating data. In some embodiments, the data uploading system 100 may include a server 110, a network 120, a terminal 130, and a storage device 140.

The server 110 may process data and/or information obtained from the network 120, the terminal 130, and/or the storage device 140. In some embodiments, the server 110 may be a single server or a server group. The server group may be centralized, or distributed (e.g., the server 110 may be a distributed system). In some embodiments, the server 110 may be local or remote. For example, the server 110 may access information and/or data stored in the terminal 130, and/or the storage device 140 via the network 120. As another example, the server 110 may be directly connected to the terminal 130, and/or the storage device 140 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may be constructed as a codis cluster. The Codis may be a distributed Redis solution. For an upper layer application, connecting to Codis Proxy and connecting to native Redis Server have no obvious difference. The upper layer application may be used as a stand-alone Redis. The lower layer of the Codis may handle the request forwarding, non-stop data migration, etc. The Codis may include a Codis Proxy (codis-proxy), a Codis Manager (codis-config), a Codis Redis (codis-server), and a Zookeeper. Codis-proxy may be a Redis proxy service connected to a client and realizing the Redis protocol. Codis-proxy itself may be stateless. In a business, multiple codis-proxies may be deployed. Codis-config may be configured as Codis management tool having functions including, for example, supporting adding and/or deleting Redis nodes, adding and/or deleting Proxy nodes, initiating data migration, etc. Codis-config may also be associated with a HTTP server, which may launch a dashboard. Users may directly observe the operation status of Codis cluster in a browser. Codis-server may be a Redis branch of Codis project maintenance. The codis-proxy and the codis-config may operate normally when interacted with this version of Redis. Codis may rely on the ZooKeeper to store the data routing table and the metadata of the codis-proxy nodes, and the commands launched by the codis-config are synchronized to each surviving codis-proxy via the ZooKeeper. Codis may distinguish different products in accordance with a Namespace. The products with different names may not conflict with each other in the configuration. As shown in FIG. 1, the server 110 may be constructed as a codis cluster including multiple servers 110-1, 110-2, 110-2, etc.

The network 120 may facilitate the exchange of information and/or data. In some embodiments, one or more components in the data uploading system 100 (e.g., the server 110, the terminal 130, the storage device 140, etc.) may send information and/or data to other component(s) in the data uploading system 100 via the network 120. For example, the server 110 may obtain/acquire data from the terminal 130 via the network 120. In some embodiments, the network 120 may be any type of wired or wireless network, or a combination thereof. Merely by way of example, the network 130 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2 . . . , through which one or more components of the data uploading system 100 may be connected to the network 120 to exchange data and/or information.

The terminal 130 may be a requestor terminal or a provider terminal. The requestor terminal may be referred to a mobile terminal that is used by a service requestor to request or order a service. For example, the requestor terminal may be a smart phone, a PDA, a tablet computer, etc. The provider terminal may be referred to a mobile terminal that is used by a service provider to provide a service or to facilitate the providing of the service. In some embodiments, the provider terminal may be the same or similar type as the requestor terminal. For example, the service provider may use a smart phone, a tablet computer, a built-in device in a motor vehicle, a laptop computer, a desktop computer etc., as the provider terminal to facilitate the providing of the service. As another example, the provider terminal may include a taxi, a shuttle bus, a limousine, a bus, a shared-bicycle, a shared-scooter, etc., that provide the service to the requestor. The terminal 130 may collect and store information related to a plurality of orders which may be requested by the users or requestors. In some embodiments, the user of the terminal 130 may be someone other than the requestor. For example, a user A of the requestor terminal may use the requestor terminal to send a service request for a user B, or receive service and/or information or instructions from the server 110. In some embodiments, a provider may be a user of a provider terminal. In some embodiments, the user of the provider terminal may be someone other than the provider. For example, a user C of the provider terminal may user the provider terminal to receive a service request for a user D, and/or information or instructions from the server 110. In some embodiments, “requestor” and “requestor terminal” may be used interchangeably, and “provider” and “provider terminal” may be used interchangeably.

In some embodiments, the terminal 130 may include a mobile device 130-1, a tablet computer 130-2, a laptop computer 130-3, and a built-in device in a motor vehicle 130-4, or the like, or any combination thereof. In some embodiments, the mobile device 130-1 may include a smart home device, a wearable device, a mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a bracelet, footgear, glasses, a helmet, a watch, clothing, a backpack, a smart accessory, or the like, or any combination thereof. In some embodiments, the mobile device may include a mobile phone, a personal digital assistance (PDA), a gaming device, a navigation device, a point of sale (POS) device, a laptop, a desktop, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google Glass™, an Oculus Rift™, a Hololens™, a Gear VR™, etc. In some embodiments, a built-in device in the motor vehicle 130-4 may include an onboard computer, an onboard television, etc: In some embodiments, the terminal 130 may be a device with positioning technology for locating the position of the requestor and/or the terminal 130.

The storage device 140 may store data and/or instructions. In some embodiments, the storage device 140 may store data obtained from the terminal 130. In some embodiments, the storage device 140 may store data and/or instructions that the server 110 may execute or use to perform exemplary methods described in the present disclosure. In some embodiments, the storage device 140 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 140 may be connected to the network 120 to communicate with one or more components in the data uploading system 100 (e.g., the server 110, the terminal 130, etc.). One or more components in the data uploading system 100 may access the data or instructions stored in the storage device 140 via the network 120. In some embodiments, the storage device 140 may be directly connected to or communicate with one or more components in the data uploading system 100 (e.g., the server 110, the terminal 130, etc.). In some embodiments, the storage device 140 may be part of the server 110.

In some embodiments, the storage device 140 may be implemented as a proxy server. The storage device 140 may proxy the network users to obtain network information. The storage device 140 may be a transfer station of the network information to store the data in a buffer memory. More importantly, the proxy server is an important security feature provided by the Internet link, which is helpful to protect the privacy and security of the network endpoint.

In some embodiments, one or more components in the data uploading system 100 (e.g., the server 110, the terminal 130, etc.) may have permission to access the storage device 140. In some embodiments, one or more components in the data uploading system 100 may read and/or modify information relating to the requestor, provider, and/or the public when one or more conditions are met. For example, the server 110 may read and/or modify one or more users' information after a service is provided. As another example, the provider terminal may access information relating to the requestor when receiving a service request from the requestor terminal, but the provider terminal may not modify the relevant information of the requestor.

In some embodiments, information exchanging of one or more components in the data uploading system 100 may be achieved by way of requesting a data service. The object of the data service request may be any product. In some embodiments, the product may be a tangible product or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

FIG. 2 is a schematic diagram illustrating exemplary hardware and software components of an exemplary computing device on which the server 110, the requestor terminal 130, and/or the storage device 140 may be implemented according to some embodiments of the present disclosure. For example, the server 110 may be implemented on the computing device 200 and configured to perform functions of the server 110 disclosed in this disclosure.

The computing device 200 may be a general-purpose computer or a special-purpose computer; both may be used to implement a data uploading system in the present disclosure. The computing device 200 may be used to implement any component of the data uploading as described herein. For example, the server 110 may be implemented on the computing device 200, via its hardware, software program, firmware, or a combination thereof. Although only one such computer is shown, for convenience, the computer functions relating to the data uploading as described herein may be implemented in a distributed fashion on a number of similar platforms, to distribute the processing load.

The computing device 200, for example, may include COM ports 250 connected to and from a network connected thereto to facilitate data communications. The computing device 200 may also include a central processing unit (CPU) 220, in the form of one or more processors, for executing program instructions. The computing device 200 may include an internal communication bus 210, program storage and data storage of different forms, for example, a disk 270, and a read only memory (ROM) 230, or a random access memory (RAM) 240, for various data files to be processed and/or transmitted by the computer. The computing device 200 may also include program instructions stored in the ROM 230, RAM 240, and/or any other type of non-transitory storage medium to be executed by the CPU 220. The methods and/or processes of the present disclosure may be implemented as the program instructions. The computing device 200 also includes an I/O component 260, supporting input/output between the computing device and other components therein. The computing device 200 may also receive programming and data via network communications.

Merely for illustration, only one CPU and/or processor is illustrated in the computing device 200. However, it should be noted that the computing device 200 in the present disclosure may also include multiple CPUs and/or processors, thus operations and/or method steps that are performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

Those skilled in the art will recognize that the present teachings are amenable to a variety of modifications and/or enhancements. For example, although the implementation of various components described herein may be embodied in a hardware device, it may also be implemented as a software only solution, for example, an installation on an existing server. In addition, the computing device 200 as disclosed herein may be implemented as a firmware, firmware/software combination, firmware/hardware combination, or a hardware/firmware/software combination.

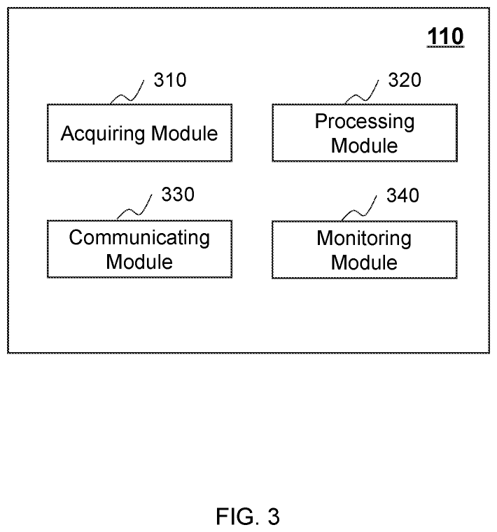

FIG. 3 is a block diagram illustrating an exemplary server according to some embodiments of the present disclosure. The server 110 may include an acquiring module 310, a processing module 320, a communicating module 330, and a monitoring module 340. In some embodiments, there may be interconnections between these modules. For example, the processing module 320 may receive information from the acquiring module 310, and send information to the communicating module 330.

The acquiring module 310 may be configured to obtain data which may be used to be processed (e.g., stored, uploaded, etc.). In some embodiments, the acquiring module 310 may obtain the data from the terminal 130 (e.g., a requestor terminal or a provider terminal) via the network 120. In some embodiments, the acquiring module 310 may obtain data in the server 110. In some embodiments, the obtained data may be transmitted to the processing module 320 for further processing, for example, the processing module 320 may analyze the data and record information related to the data (e.g., data size, data receiving time, data type, etc.).

In some embodiments, the data may include an entire data item, a partial data item, and/or an increment data item associated with two data items. The entire data item may include all of the information related to an object such as, a terminal, a server, a mobile application implemented on the terminal, an individual service order generated by the mobile application, etc. A partial data item may include part of the information related to an object. The entire data item and the partial data item may be associated with at least one of a period of time, a geographic location, a particular user group, and the combination thereof. The increment data item associated with two data items may include information indicative of the difference between two data items. For example, the increment data item may indicate a temporal difference between the two data items. As another example, the increment data item may indicate a spatial difference between the two data items. As yet another example, the increment data item may indicate a user group difference between the two data items. The entire data item may further include a previous entire data item and a new entire data item. The previous entire data item may be downloaded from the storage device 140 and saved in the server 110. The new entire data item may be obtained from the terminal 130 and transmitted to the server 110 in order to compare with the previous entire data item. In some embodiments, the previous entire data item may refer to an old version of the entire data item previously saved in the storage device 140. The new entire data item may refer to a new version of the entire data item obtained via various sources and to be uploaded to update the previous entire data item saved in the storage device 140. When a data uploading is accomplished, the previous entire data item saved in the storage device 140 is updated with the new entire data item. For example, the previous entire data item may include information related to a plurality of online taxi orders generated in New York City in 2016. The new entire data item may include information related to a plurality of online taxi orders generated in New York City from January, 2016 to April, 2017. An increment data item may be determined as the plurality of online taxi orders generated in New York City from January, 2017 to April, 2017. After uploading the increment data item to the storage device 140, the previous entire data item may be updated to include the information related to a plurality of online taxi orders generated in New York City from January, 2016 to April, 2017.

In some embodiments, the entire data item associated with an object may include but not limited to data related to orders, data related to vehicles, data related to vehicle travel routes, payment data, traffic data, location data, data related to travel time, data related to passengers' preference, data related to drivers' preference, data related to departure location, destination data, or the like, or any combination thereof. In some embodiments, different versions or different instances of the entire data items may be obtained and stored in a storage component of the data uploading system 100. When an uploading task is scheduled, the acquiring module 310 may select the previous entire data item and the new entire data item and send to the processing module 320 to determine the increment data item.

The processing module 320 may be configured to process the obtained data to determine the increment data item. The processing operation may include but not limited to identification, classification, filtering, calculating, storing, or the like, or any combination thereof.

In some embodiments, the processing module 320 may be configured to determine an increment data item based on the previous entire data item and the new entire data item. In some embodiments, merely the increment data item may be uploaded to the server 110 to update the previous entire data item for the efficiency of data updating. In some embodiments, the entire data item may be uploaded to the server 110 to update the previous entire data item.

In some embodiments, the processing module 320 may determine a storage strategy for the increment data item or the entire data item. The storage strategy may be determined based on storage location, storage time, storage volume, storage pattern, or the like, or any combination thereof. The processing module 320 may determine one or more attributes associated with the data to be stored (e.g., the entire data item, the increment data item, etc.). The one or more attributes associated with the data may include but not limited to data size, data recording time, data type, time point of the data updating, data physical feature, or the like, or any combination thereof.

Further, the processing module 320 may be configured to determine an uploading strategy for the increment data item or the entire data item. The uploading strategy may be different depending on whether the increment data item or the entire data item is to be uploaded. For example, as the size of the increment data item is small, the processing module 320 may determine the uploading strategy as transmitting the entire increment data item at one time. As another example, as the size of the entire data item is large, the processing module 320 may determine the uploading strategy as segmenting the entire data item and transmitting the segmented entire data item at different time, respectively.

In some embodiments, the processing module 320 may also determine the uploading strategy based on the data transmitting speed over the network, the bandwidth of the network, uploading time, and the destination IP address in the network that the data is to be uploaded, etc. In some embodiments, the processing module 320 may determine a strategy for a data rollback. For example, upon detecting an anomalous situation during the uploading of the increment data item or the entire data item over the network, the processing module 320 may execute a data rollback to check and/or recover the data.

The communication module 330 may be configured to transmit the data associated with new entire data item to at least one server. For example, the communication module 330 may send the increment data item or the new entire data item to one of the server 110-2 and/or server 110-3. As another example, the communication module 340 may send the notification associated with the abnormality to one of the server 110-2 and/or server 110-3.

In some embodiments, the communication module 330 may receive a response from the server 110. The response may indicate that the server 100 requests to resend the data due to the data loss during transmission. As another example, the response may indicate that the server 100 has received the complete data and instructs the transmission session to be closed.

In some embodiments, upon receiving the response from the server 110, the communication module 330 may further send a reply (e.g., resend the increment data item) to the server 110 based on the response. For example, the communication module 330 may resend the increment data item to the server 110.

The monitoring module 340 may be configured to monitor the process of the communication. The communication herein refers to transmitting the increment data item or the entire data item to at least one server 110. The monitoring module 340 may automatically detect the abnormality during the transmission of the increment data item and instruct the processing module 320 to take further actions.

In some embodiments, the monitoring module 340 may monitor data traffic, anomalous data, and data statistics, etc. When an anomalous situation during transmitting the increment data item to a server is detected, the monitoring module 340 may send a prompt message to the server for warning the users or technicians. The prompt message may include but not limited to a photo, a word, a voice, a video, a warning light, or the like, or any combination thereof. The criteria of determining an anomalous situation may be set by the users or technicians in advance.

The acquiring module 310, the processing module 320, the communicating module 330, and the monitoring module 340 in the server 110 may be connected to or communicated with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined as a single module, and any one of the modules may be divided into two or more units. For example, the processing module 320 may be integrated into the communicating module 330 as a single module which may both process the data and upload the processed data. As another example, the server 110 may include a storage module (not shown in FIG. 3) which may be configured to store the data temporarily or permanently.

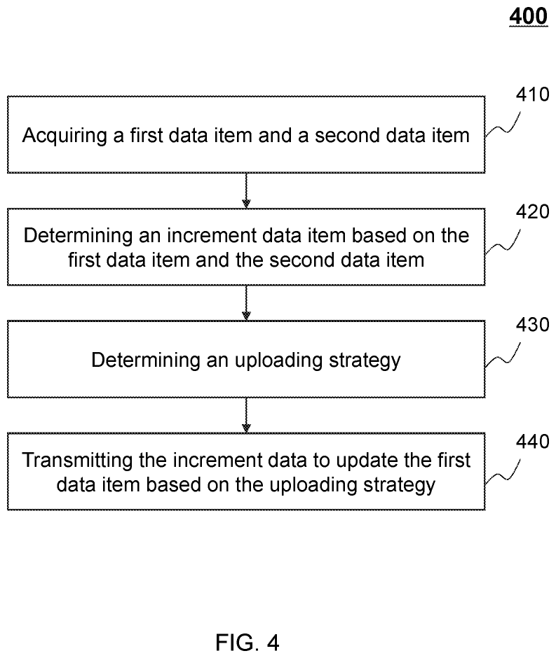

FIG. 4 is a flowchart illustrating an exemplary process for uploading offline data according to some embodiments of the present disclosure. The process 400 may be executed by the data uploading system 100. For example, the process 400 may be implemented as a set of instructions (e.g., an application) stored in the storage ROM 230 or RAM 240. The CPU 220 may execute the set of instructions and may accordingly be directed to perform the process 400. The operations of the illustrated process 400 presented below are intended to be illustrative. In some embodiments, the process 400 may be accomplished with one or more additional operations not described, and/or without one or more of the operations discussed. Additionally, the order in which the operations of the process 400 as illustrated in FIG. 4 and described below is not intended to be limiting.

In 410, the data uploading system 100 may acquire a first data item and a second data item from the storage medium (e.g., the terminal 130 or the storage device 140). In some embodiments, the first data item may be previous entire data item and the second data item may be a new entire data item. The new entire data may be an updated version of the previous entire data. In some embodiments, the first data item and the second data item may have been acquired and stored in the server (e.g., the server 110-1,110-2 or 110-3 . . . ) or storage device 140 in the data uploading system.

When a data uploading procedure is accomplished, the previous entire data item saved in the storage device 140 is updated with the new entire data item. For example, the previous entire data item may include information related to a plurality of online taxi orders generated in New York City in 2016. The new entire data item may include information related to a plurality of online taxi orders generated in New York City from January, 2016 to April, 2017. An increment data item may be determined as the plurality of online taxi orders generated in New York City from January, 2017 to April, 2017. After uploading the increment data item to the storage device 140, the previous entire data item may be updated to include the information related to a plurality of online taxi orders generated in New York City from January, 2016 to April, 2017.

In some embodiments, the entire data item associated with an object may include but not limited to data related to orders, data related to vehicles, data related to vehicle transporting routes, payment data, traffic data, location data, data related to travel time, data related to passengers' preference, data related to drivers' preference, data related to departure location, destination data, or the like, or any combination thereof. In some embodiments, different versions or different instances of the entire data items may be obtained and stored in a storage component of the data uploading system 100. When an uploading task is scheduled, the previous entire data item and the new entire data item may be selected from the storage component. In some embodiments, the server 110 may acquire the entire data item from the terminal 130 via network, or acquire the entire data item from the storage component in the server directly.

In 420, the data uploading system 100 may determine an increment data item according to the first data item and the second data item. In some embodiments, the first data item and/or the second data item may need to be processed for further uploading. The data processing operation may include but not limited to identification, classification, filtering, calculating, storing, or the like, or any combination thereof.

In some embodiments, a storage strategy for the increment data item or the entire data item may further be determined in 420. The storage strategy may be determined based on storage location, storage time, storage volume, storage pattern, or the like, or any combination thereof. And the parameters of the data may also be determined in 420. The data updating system 100 may determine one or more attributes associated with the data to be stored (e.g., the entire data item, the increment data item, etc.). The one or more attributes associated with the data may include but not limited to data size, data recording time, data type, time point of data updating, data physical feature, or the like, or any combination thereof.

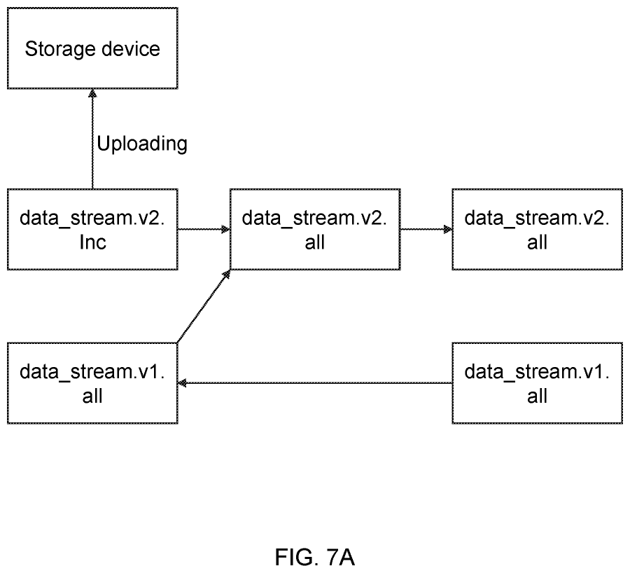

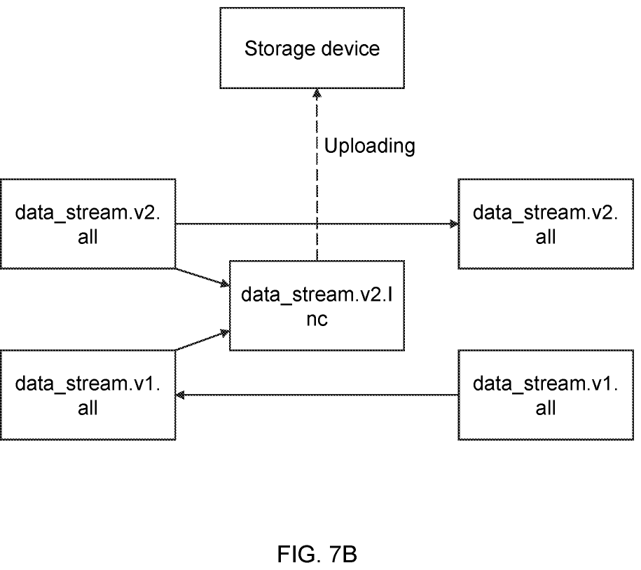

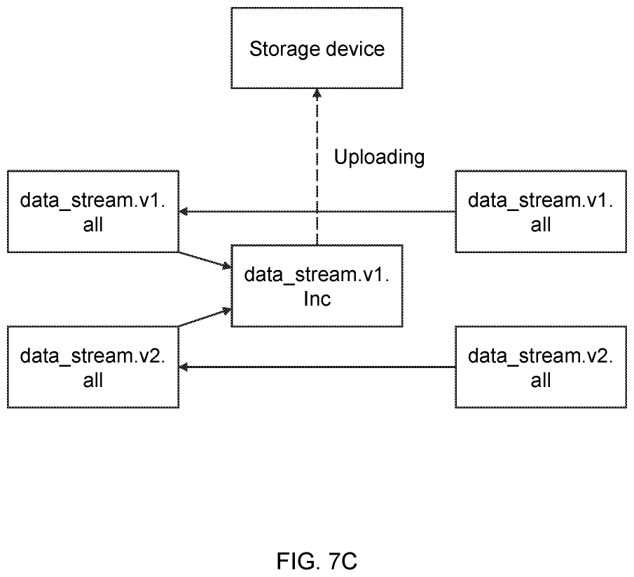

In some embodiments, the data uploading system 100 may directly acquire the increment data item without processing the previous entire data item or the new entire data item from a storage component of the server 110. The increment data item may be recorded and stored in the local storage component in real-time. The increment data item may be further uploaded to one or more servers. Meanwhile, the increment data item may be combined with the previous entire data item to generate the new entire data item in the local storage. The new entire data item in the local storage component may be stored as a previous entire data item for a subsequent data uploading. The above examples may be described in detail in FIG. 7A.

In 430, the data uploading system 100 may determine an uploading strategy for the increment data item. The uploading strategy may be different depending on whether the increment data item or the entire data item is to be uploaded. For example, as the size of the increment data item is small, the data uploading system 100 may determine the uploading strategy as transmitting the entire increment data item at one time. As another example, as the size of the entire data item is large, the data uploading system 100 may determine the uploading strategy as segmenting the entire data item and transmitting the segmented entire data item at different time, respectively. The uploading strategy may determine the ways in which the data may be uploaded. In some embodiments, the uploading methods may include but not limited to increment data item uploading and entire data item uploading.

Further, in 430 the data uploading system 100 may also determine the uploading strategy based on the data transmitting speed over the network, the bandwidth of the network, uploading time, and the destination IP address in the network that the data is to be uploaded, etc. In some embodiments, the data uploading system 100 may determine a strategy for a data rollback. For example, upon detecting an anomalous situation during the uploading of the increment data item or the entire data item over the network, the data uploading system 100 may execute a data rollback to check and/or recover the data. The detailed description of the uploading strategies may be further described in FIG. 7.

In 440, the data uploading system 100 may transmit the increment data item to update the first data item stored in the database based on the uploading strategy. For example, the data uploading system 100 may send the increment data item or the new entire data item to one of the server 110-2 and/or server 110-3. As another example, the data uploading system 100 may send the notification associated with the abnormality to one of the server 110-2 and/or server 110-3.

In some embodiments, the data uploading system 100 may transmit the data to one or more servers via the network 120. In some embodiments, the network 120 may be any type of wired or wireless network, or a combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof.

In some embodiments, the data uploading system 100 may receive a response from the one or more servers. The response may indicate that the server 100 requests to resend the data due to the data loss during transmission. As another example, the response may indicate that the server 100 has received the complete data and instructs the transmission session to be closed.

In some embodiments, upon receiving the response from the one or more servers, the data uploading system 100 may further send a reply (e.g., new increment data item) to the one or more servers based on the response. For example, the communication module 330 may resend the increment data item to the server 110.

In some embodiments, the data uploading system 100 may monitor the process of the communication in 440. The communication herein refers to transmitting the increment data item or the entire data item to at least one server 110. The data uploading system 100 may automatically detect the abnormality during the transmission of the increment data item and instruct the data uploading system 100 to take further actions.

In some embodiments, the data uploading system 100 may monitor data traffic, anomalous data, and data statistics, etc. When an anomalous situation during transmitting the increment data item to a server is detected, the data uploading system 100 may send a prompt message to the server for warning the users or technicians. The prompt message may include but not limited to a photo, a word, a voice, a video, a warning light, or the like, or any combination thereof. The criteria of determining an anomalous situation may be set by the users or technicians in advance. Once there is an abnormity appearing, the prompt message may be displayed and the data associated with the abnormity may be stored for further operations.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step or a responding step) may be added elsewhere in the exemplary process/method 400.

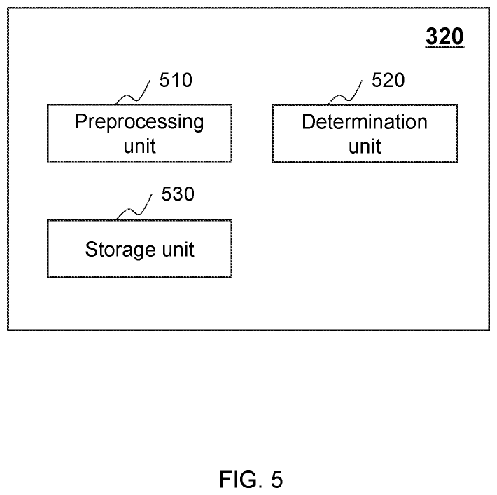

FIG. 5 is a block diagram illustrating an exemplary processing module according to some embodiments of the present disclosure. The processing module 320 may include a preprocessing unit 510, a determination unit 520, and a storage unit 530. In some embodiments, there may be interconnections between these units. For example, the determination unit 520 may receive information from the preprocessing unit 510, and send information to the storage unit 530.

The preprocessing unit 510 may be configured to preprocess the previous entire data item and/or new entire data item. The preprocessing operation may include but not limited to filtering, classifying, normalizing, standardizing, or the like, or any combination thereof.

In some embodiments, filtering the previous data item and/or the new entire data item may refer to filtering out the noise or the interference data that are added to the main data. For example, the acquired entire data item may comprise noise data or redundancy data, which may decrease the accuracy of the data determination result. In some embodiments, classifying the previous entire data item and/or new entire data item may refer to classifying the previous entire data item and/or new entire data item according to a preset classification standard. The preset classification standard may include but not limited to linear classification, area classification, composite classification, or the like, or any combination thereof. In some embodiments, normalizing the previous entire data item and/or new entire data item may refer to processing the previous entire data item and/or new entire data item based on an algorithm such that the associated data value is restrained to a certain range. In some embodiments, standardizing the previous entire data item and/or new entire data item may refer to transforming the previous entire data item and new entire data item such that the previous entire data item and new entire data item are in the same data structure. In some embodiments, the preprocessed data may be send to the determination unit 520 for further operation.

The determination unit 520 may be configured to determine the increment data item based on the preprocessed previous entire data item and the preprocessed new entire data item. In some embodiments, merely the increment data item may be uploaded to the server 110 to update the previous entire data item for the efficiency of data updating. In some embodiments, the entire data item may be uploaded to the server 110 to update the previous entire data item. The determination unit 520 may determine the new entire data item and confirm that the new entire data item is the latest version of the entire data item.

In some embodiments, the determination unit 520 may compare the new entire data item and previous entire data item to get the increment data item. For example, the determination unit 520 may perform a subtraction operation between the new entire data item and previous entire data item to get the increment data item. The subtraction algorithm may be various algorithms well-known to a person having ordinary skill in the art. Further, the subtraction algorithm may be determined according to the attributes of the new entire data item and previous entire data item.

In some embodiments, the determination unit 520 may also be configured to determine a storage strategy for the data. The storage strategy may be determined based on storage location, storage time, storage volume, storage pattern, or the like, or any combination thereof. And the parameters of the data may also be determined by the determination unit 520. The determination unit 520 may determine one or more attributes associated with the data to be stored (e.g., the entire data item, the increment data item, etc.). The one or more attributes associated with the data may include but not limited to data size, data recording time, data type, time point of data updating, data physical feature, or the like, or any combination thereof.

The storage unit 530 may be configured to store the data according to the determined storage strategy. The storage unit 530 may be a component with storage function in the server 110. The storage unit 530 may store the data temporarily or permanently. In some embodiments, the server may detect the network status. Once the network status indicates that the network resources are available for transmission, the storage unit 530 may send the data stored therein to the communication module 340 to upload the data via the network.

The preprocessing unit 510, the determination unit 520, and the storage unit 530 in the processing unit 320 may be connected to or communicated with each other via a wired connection or a wireless connection. The wired connection may include a metal cable, an optical cable, a hybrid cable, or the like, or any combination thereof. The wireless connection may include a Local Area Network (LAN) a Wide Area Network (WAN), a Bluetooth, a ZigBee, a Near Field Communication (NFC), or the like, or any combination thereof. Two or more of the units may be combined as a single unit, and any one of the modules may be divided into two or more units.

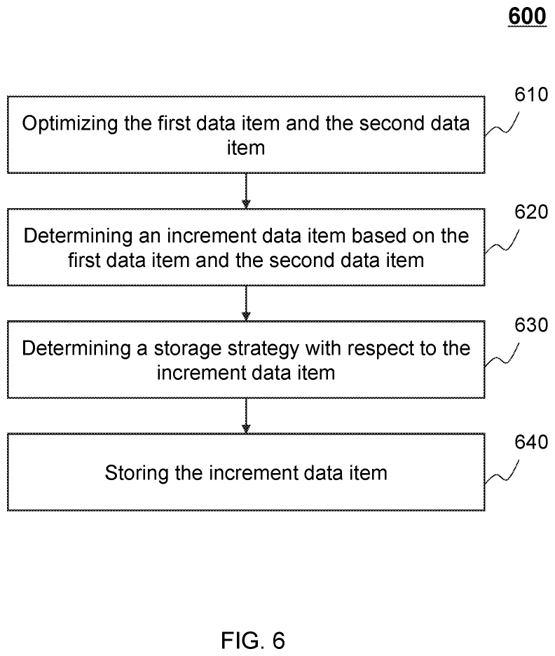

FIG. 6 is a flowchart illustrating an exemplary process for processing offline data according to some embodiments of the present disclosure. The process 600 may be executed by the data uploading system 100. For example, the process 600 may be implemented as a set of instructions (e.g., an application) stored in the storage ROM 230 or RAM 240. The CPU 220 may execute the set of instructions and may accordingly be directed to perform the process 600. The operations of the illustrated process presented below are intended to be illustrative. In some embodiments, the process may be accomplished with one or more additional operations not described, and/or without one or more of the operations discussed. Additionally, the order in which the operations of the process as illustrated in FIG. 6 and described below is not intended to be limiting.

In 610, the data updating system 100 may optimize the first data item and the second data item. The first data item may refer to a previous entire data item, and the second data item may refer to a new entire data item. The data optimizing includes but not limited to data filtering, data classifying, data normalizing, data standardizing, or the like, or any combination thereof.

In 620, the data updating system 100 may determine an increment data item based on the first data item and the second data item. The determining algorithm may be associated with the attributes of the optimized previous entire data item and new entire data item. The attributes associated with the data may include but not limited to data size, data recording time, data type, time point of data updating, data physical feature, or the like, or any combination thereof.

In 630, the data updating system 100 may determine a storage strategy with respect to the increment data item. The storage strategy may be determined according to the attributes of the increment data item. In some embodiments, the storage strategy may be preset by the users or technicians.

In 640, the data updating system 100 may store the increment data item in a component in the server 110 based on the storage strategy determined in 630.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a responding step) may be added elsewhere in the exemplary process 600.

FIG. 7A illustrates a diagram of an exemplary uploading procedure according to some embodiments of the present disclosure. As illustrated in FIG. 7A, the server 110 may load the previous entire data item (hereinafter referred to as “data_stream.v1.all”). The server 110 may obtain the increment data item (hereinafter referred to as “data_stream.v2.Inc”). Further, the server 110 may determine the new entire data item (hereinafter referred to as “the data_stream.v2.all”) by combining the data_stream.v1.all and data_stream.v2.Inc. The data_stream.v2.all may be written in the local storage component (e.g., in the server 110). The data_stream.v2.all may be stored as a previous entire data item for a subsequent data uploading. Meanwhile, the data_stream.v2.Inc may be uploaded to a storage device via at least one server when the network is available for transmission.

FIG. 7B illustrates a diagram of an exemplary uploading procedure according to some embodiments of the present disclosure. As illustrated in FIG. 7B, the server may obtain the data_stream.v1.all and the data_stream.v2.all. The server 110 may further determine the data_stream.v2.Inc based on the data_stream.v1.all and data_stream.v2.all. For example, the server 110 may perform a subtraction operation between the data_stream.v1.all and data_stream.v2.all. The data_stream.v2.all may be t written in the local storage component (e.g., in the server 110). Meanwhile, the data_stream.v2.Inc may be uploaded to a storage device via at least one server when the network is available for transmission.

FIG. 7C illustrates a diagram of an exemplary uploading procedure according to some embodiments of the present disclosure. As illustrated in FIG. 7C, the process may refer to a data rollback process. The server 110 may load the data_stream.v2.all and the data_stream.v1.all from the local storage component in the server 110. Further, the data_stream.v1.Inc (another increment data item) may be determined based on the data_stream.v1.all and data_stream.v2.all. The data_stream.v1.Inc may be uploaded to a storage device via at least one server for data recovery accordingly.

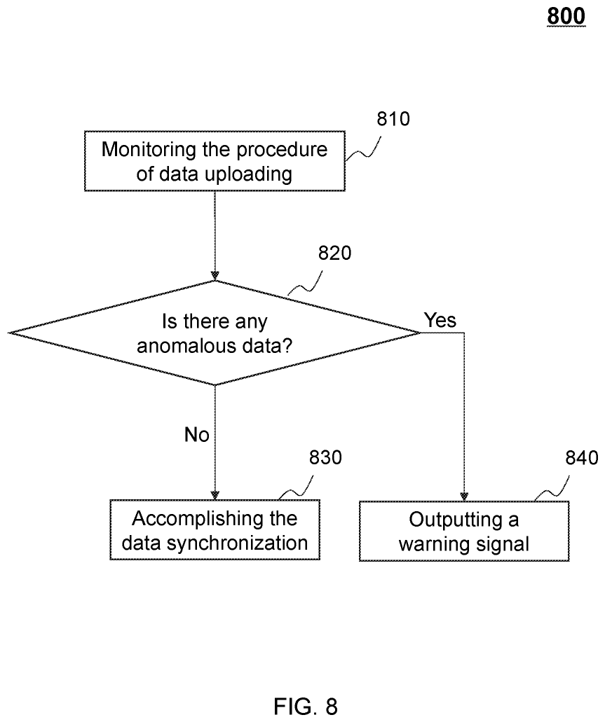

FIG. 8 is a flowchart illustrating an exemplary process for monitoring the uploading procedure according to some embodiments of the present disclosure. The process 800 may be executed by the data uploading system 100. For example, the process 800 may be implemented as a set of instructions (e.g., an application) stored in the storage ROM 230 or RAM 240. The CPU 220 may execute the set of instructions and may accordingly be directed to perform the process 800. The operations of the illustrated process presented below are intended to be illustrative. In some embodiments, the process may be accomplished with one or more additional operations not described, and/or without one or more of the operations discussed. Additionally, the order in which the operations of the process as illustrated in FIG. 8 and described below is not intended to be limiting.

In 810, the data uploading system 100 may monitor the uploading procedure which has been described in 440 of the process 400 in FIG. 4. In some embodiment, 810 may be executed by the monitoring module 340 in the server 110. The data uploading system 100 may monitor data traffic, anomalous data, or data statistics, etc.

In 820, the data uploading system 100 may determine as to whether there is any anomalous data or anomalous situation. And a prompt message may be outputted to users according to the determination result. The prompt message may be associated with a warning signal or an accomplishment command. The prompt message may have a form including but not limited to a photo, a word, a voice, a video, a warning light, or the like, or any combination thereof.

In 830, in response to a determination that there is no anomalous data or anomalous situation, a prompt message associated with the accomplishment command may be prompted to users. Otherwise, in 840, in response to a determination that there is anomalous data or anomalous situation, a warning signal may be prompted to users to warn the users that the uploading procedure is not working normally. For example, the warning signal may indicate that the received increment data item is incomplete due to the loss during uploading. As a result, the data uploading system 100 may resend the increment data item once the network becomes available.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

We claim:

1. A system, comprising:
at least one processor;
at least one non-transitory computer-readable storage medium including a set of instructions for updating data; and
at least one communication module connected to a network, wherein when executing the set of instructions, the at least one processor is directed to:
acquire a first data item from a database;
acquire a second data item, the second data item being an updated version of the first data item;
determine an increment data item based on the first data item and the second data item;
determine an updating strategy with respect to the increment data item; and
transmit the increment data item to update the first data item stored in the database via the network based on the updating strategy.

2. The system of claim 1, wherein to determine an increment data item based on the first data item and the second data item, the at least one processor is further directed to:
filter the first data item and the second data item;
classify the first data item and the second data item; or
standardize the first data item and the second data item.

3. The system of claim 2, wherein to standardize the first data item and the second data item, the at least one processor is further directed to:
transform the first data item and the second data item to be in the same data structure.

4. The system of claim 1, wherein to determine an increment data item based on the first data item and the second data item, the at least one processor is further directed to:
perform a subtraction operation between the first data item and the second data item.

5. The system of claim 1, wherein the updating strategy with respect to the increment data item is based on at least one of data structure of the increment data item, a size of the increment data item, or a type of the increment data item.

6. The system of claim 1, wherein the updating strategy comprises at least one of entire updating of the first data item stored in the database, increment updating of the first data item stored in the database, or data rollback of the first data item stored in the database.

7. The system of claim 1, wherein to transmit the increment data item to update the first data item stored in the database via the network, the at least one processor is further directed to:
transmit the increment data item to a proxy server; and
transmit the increment data item from the proxy server to at least one server to update the first data item stored in the database.

8. The system of claim 1, the at least one processor is further directed to:
monitor at least one of data traffic in the network, anomalous data in the network, or data statistics associated with the increment data item.

9. A method implemented on a computing device having at least one processor, at least one non-transitory computer-readable storage medium, and at least one communication module connected to a network, comprising:
acquiring, by the at least one processor, a first data item from a database;
acquiring, by the at least one processor, a second data item, the second data item being an updated version of the first data item;
determining, by the at least one processor, an increment data item based on the first data item and the second data item;
determining, by the at least one processor, an updating strategy with respect to the increment data item; and
transmitting, by the at least one processor, the increment data item to update the first data item stored in the database via the network based on the updating strategy.

10. The method of claim 9, wherein the determining, by the at least one processor, an increment data item based on the first data item and the second data item further comprising at least one of:
filtering the first data item and the second data item;
classifying the first data item and the second data item; or
standardizing the first data item and the second data item.

11. The method of claim 10, wherein the standardizing the first data item and the second data item further comprising:
transforming the first data item and the second data item to be in the same data structure.

12. The method of claim 9, wherein the determining, by the at least one processor, an increment data item based on the first data item and the second data item further comprising:
performing a subtraction operation between the first data item and the second data item.

13. The method of claim 9, wherein the updating strategy with respect to the increment data item is based on at least one of data structure of the increment data item, a size of the increment data item, or a type of the increment data item.

14. The method of claim 9, wherein the updating strategy comprises at least one of entire updating of the first data item stored in the database, increment updating of the first data item stored in the database, or data rollback of the first data item stored in the database.

15. The method of claim 9, wherein the transmitting the increment data item to update the first data item stored in the database via the network further comprising:
transmitting the increment data item to a proxy server; and
transmitting the increment data item from the proxy server to at least one server to update the first data item stored in the database.

16. The method of claim 9, further comprising:
monitoring at least one of data traffic in the network, anomalous data in the network, or data statistics associated with the increment data item.

17. A non-transitory computer readable medium embodying a computer program product, the computer program product comprising instructions configured to cause a computing device to:
acquire a first data item and a second data item;
determine an increment data item based on the first data item and the second data item;
determine an updating strategy with respect to the increment data item; and
transmit, monitored by the at least one monitoring module, the increment data item to the at least one database online based on the uploading rule.

18. The medium of claim 17, wherein to determine an increment data item based on the first data item and the second data item, the instructions are further configured to cause a computing device to:
filter the first data item and the second data item;
classify the first data item and the second data item; or
standardize the first data item and the second data item.

19. The medium of claim 17, wherein to transmit the increment data item to update the first data item stored in the database via the network, the instructions are further configured to cause a computing device to:
transmit the increment data item to a proxy server; and
transmit the increment data item from the proxy server to at least one server to update the first data item stored in the database.

20. The medium of claim 17, wherein the instructions are further configured to cause a computing device to:
monitor at least one of data traffic in the network, anomalous data in the network, or data statistics associated with the increment data item.
